(19) United States
(12) Patent Application Publication
(10) Pub. No.: US 2005/0260387 A1
(43) Pub. Date: Nov. 24, 2005

(54) Three-dimensional textured article and methods of making same

(75) Inventor: Ronald E. Lux, White Bear Lake, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/849,972

(22) Filed: May 20, 2004

(51) Int. Cl. B32B 5/12

(52) U.S. Cl. 428/143

(57) ABSTRACT

A textured nonwoven article that has a substantially permanent three-dimensional shape. The three-dimensional textured article can be used, for example, as an abrasive article or a stair tread covering.

### BACKGROUND

Textured nonwoven products made of a uniform lofty web of continuous bonded polyamide filaments, such as the textured articles reported in U.S. Pat. No. 4,227,350 (Fitzer) and U.S. Pat. No. 6,302,930 (Lux), have found successful application for treating or conditioning various types of surfaces. These applications include, for example, removing mill scale from steel coil stock, blending of weld lines, preparing surfaces for painting or other coating operation, and removing various surface coatings in repair and maintenance operations.

These successes have spurred the pursuit of adding value to these textured nonwoven products by improving their performance in current applications and modifying the textured nonwoven for use in applications beyond surface conditioning.

### SUMMARY

The present invention provides a three-dimensional textured article that has a substantially permanent three-dimensional shape. In one aspect, the present invention provides a three-dimensional textured article having a first portion having a first surface, a second surface, and at least one side wall extending between the first surface and the second surface. The three-dimensional textured article also includes a second portion having a first surface positioned at a substantially permanent angle relative to the first surface of the first portion, a second surface, and at least one side wall extending between the first and second surfaces of the second portion. The angle between the first surface of the first portion and the first surface of the second portion is at least 45 degrees. The first and second portions are integral and comprise a web and a binder. The web includes a multitude of substantially continuous three-dimensionally undulated thermoplastic filaments autogenously bonded where they contact one another. The filaments have a diameter in a range from 0.1 to 3 mm and the web has a coil weight in a range from 0.1 to 3.0 kg/m².

In some embodiments, the thermoplastic filaments comprise at least one of polyamide, polycaprolactam, or poly(hexamethylene adipamide). In certain embodiments, the textured article can also include a quantity of abrasive particles affixed to at least one of the first or second surfaces of the first portion.

In some embodiments, the textured article includes a third portion integral with at least one of the first or the second portion. The third portion includes a first surface, a second surface, and at least one side wall extending between the first surface and the second surface of the third portion. In certain embodiments, the third portion is integral with the second portion, and the first surface of the third portion is positioned at an angle of at least 45 degrees relative to the first surface of the second portion.

The present invention also provides methods for making a three-dimensional textured article according to the present invention.

### BRIEF DESCRIPTION OF THE DRAWINGS

FIG. 1 is a perspective view of a stairway having exemplary three-dimensional textured articles according to the present invention on the lower two stairs;.

FIG. 2 is a perspective view of an exemplary three-dimensional textured article according to the present invention having two conjoined portions;

FIG. 3 is a perspective view of an exemplary three-dimensional textured article according to the present invention having three conjoined portions;

FIG. 4 is a schematic illustration of an exemplary process used to make a web for manufacturing a three-dimensional article according to the present invention; and

FIG. 5 is a perspective view of exemplary forming trays used to manufacture exemplary three-dimensional textured articles according to the present invention.

### DETAILED DESCRIPTION

The value of a textured nonwoven product, such as an abrasive article, is increased if it can be tailored to match the particular geometries of the intended application. For example, a conditioning operation that requires abrading adjacent sides of a workpiece at an angle relative to one another can benefit from a textured nonwoven abrasive article with a three-dimensional shape that conforms to the geometry of the workpiece.

The value of a textured nonwoven product is also increased if it can be used for a variety of end uses. For example, a textured nonwoven product that can function as an anti-slip stair tread covering as well as an abrasive article has the potential to reduce manufacturing costs. Manufacturing costs can be reduced, for example, through increased equipment utilization.

The present invention provides a three-dimensional textured article that has a substantially permanent three-dimensional shape. The term “substantially permanent” refers to a shape that is retained after application of a force of a magnitude normally employed during shipping and handling of the three-dimensional textured article. Accordingly, a three-dimensional article according to the present invention will retain its three-dimensional shape after normal handling by the user of the article such that it remains useful for its intended purpose. For example, a three-dimensional textured article according to the present invention can be shipped in a box to a customer and the customer can use the article without having to permanently modify the shape of the article.

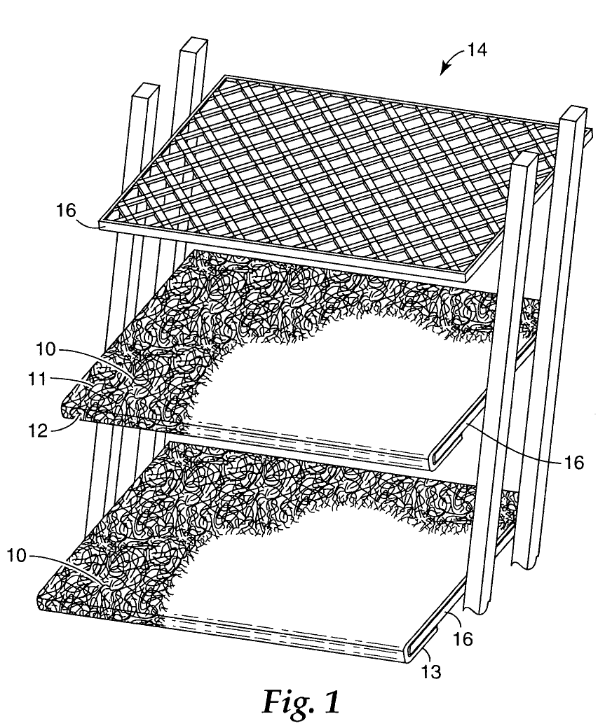

FIG. 1 is a perspective view of a stairway 14 having exemplary three-dimensional textured articles 10 according to the present invention on the lower two stairs. As shown in FIG. 1, the three-dimensional textured articles 10 have a first portion 11 that forms the tread surface, a second portion 12 that covers the front of the step 16, and a third portion 13 that is positioned underneath the front edge of the steps 16. The first portion 11, second portion 12, and third portion 13 are integral and comprise a textured nonwoven web.

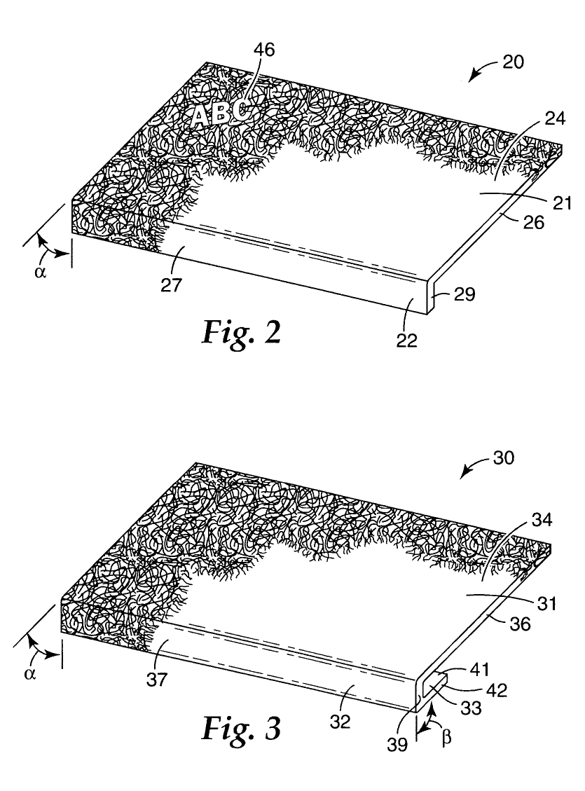

FIG. 2 is a perspective view of an exemplary three-dimensional textured article 20 according to the present invention having two conjoined portions. As shown in FIG. 2, the first portion 21 and second portion 22 are integral and comprise a textured nonwoven web. The first portion 21 has a first surface 24, a second surface opposite the first surface 24, and at least one sidewall 26 extending between the first surface 24 and the second surface.

The second portion 22 has a first surface 27, a second surface opposite the first surface 27, and at least one sidewall 29 extending between the first surface 27 and the second surface.

The first surface 27 of the second portion 22 is positioned at an angle a relative to the first surface 24 of the first portion 21. In certain embodiments, angle α is at least 45 degrees. In other embodiments, angle α is at least 60 degrees. In yet further embodiments, angle α is at least 75 degree. In certain embodiments, angle α is about 90 degrees. Alternatively, angle α can be about 180 degrees such that the second surface of the first portion 21 and the second surface of the second portion 22 are opposite one another. When positioned opposite one another, the second surface of the first portion and the second surface of the second portion can be in contact with one another or can be a distance apart from one another.

In certain embodiments, at least a portion of the three-dimensional article has a non-planar surface, such as a curvilinear surface. In such embodiments, the angle between surfaces of adjacent portions is determined by measuring the angle of a tangent near the center of each portion.

Embodiments of three-dimensional textured articles according to the present invention shown in FIG. 2 can be used, for example, as a stair tread covering. The first portion 21 forming the tread surface and the second portion contacting the front edge of the step. The second portion can be used to help keep the three-dimensional textured article from sliding about the surface of the step.

Alternatively, embodiments of three-dimensional textured articles shown in FIG. 2 can be used as an abrasive article. The abrasive article can be used, for example, to simultaneously condition two interior or exterior surfaces that are at an angle to one another. Other uses for a three-dimensional textured article of the present invention include simplified location of an abrasive article on a tool. For example, the shape of the three-dimensional textured abrasive article according to the present invention can be matched to the outer surface of a holding tool, such as, for example, a sanding block.

In some embodiments, three-dimensional textured articles according to the present invention include a graphic 46 as shown in FIG. 2. The graphic can be applied by any method known in the art, including for example, embossing, applique, or printing. The graphic can be used, for example, to identify the three-dimensional article, to display a warning, or for advertisement. For example, if the three-dimensional article is designed for use on an industrial stairway, the graphic could warn of hazards, such as ice or other slippery materials present in the area. The graphic may be or include copyrightable material or be in the form of a trademark. In one aspect, the graphic is in the form of copyrightable material or in the form of a trademark (including a registered copyright or registered trademark as defined under the laws of the countries, territories, etc. of the world, including those of the United States).

The three-dimensional textured article can also be colored, for example, to increase visibility or for product identification. In certain embodiments, the three-dimensional textured article includes a yellow colorant, such as, for example, yellow pigment available from Penn Color, Inc., Doylestown, Penn., marketed under the trade designation “YELLOW PIGMENT 16Y1140 PASTE”. The yellow colorant can be used to provide safety alerts when the three-dimensional textured article is designed for use as an anti-slip material on a stair tread or ladder rung.

FIG. 3 is a perspective view of an exemplary three-dimensional textured article according to the present invention having two conjoined portions. As shown in FIG. 3, the first portion 31, the second portion 32, and the third portion 33 are integral and comprise a textured nonwoven web. The first portion 31 has a first surface 34, a second surface opposite the first surface 34, and at least one sidewall 36 extending between the first surface 34 and the second surface.

The second portion 32 has a first surface 37, a second surface opposite the first surface 37, and at least one sidewall 39 extending between the first surface 37 and the second surface. The first surface 37 of the second portion 32 is positioned at an angle a relative to the first surface 34 of the first portion 31. In certain embodiments, angle α is at least 45 degrees. In other embodiments, angle α is at least 60 degrees. In yet further embodiments, angle α is at least 75 degree. In certain embodiments, angle a is about 90 degrees. Alternatively, angle α can be about 180 degrees such that the second surface of the first portion 31 and the second surface of the second portion 32 are opposite one another. When positioned opposite one another, the second surface of the first portion and the second surface of the second portion can be in contact with one another or can be any distance apart from one another.

The third portion 33 has a first surface, a second surface 41 opposite the first surface, and at least one sidewall 42 extending between the first surface and the second surface 41. The first surface of the third portion 33 is positioned at an angle β relative to the first surface 37 of the second portion 32. In certain embodiments, angle β is at least 45 degrees. In other embodiments angle β is at least 60 degrees. In yet further embodiments, angle β is at least 75 degree. In certain embodiments, angle β is about 90 degrees. Alternatively, angle β can be about 180 degrees such that the second surface of the second portion 32 and the second surface 41 of the third portion 33 are opposite one another. When positioned opposite one another, the surfaces can be in contact with one another or can be a distance apart from one another.

In certain embodiments with three integral portions, angles α and β are both about 90 degrees such that the first portion and the third portion are substantially parallel. Alternatively, the first and third portions can have curvilinear surfaces such that the first and third portions substantially mirror one another.

In certain embodiments, the sidewalls are perpendicular to the adjoining surfaces. Alternatively, the sidewalls can be angular, rounded, or any other shape suitable for the intended end use of the three-dimensional textured article.

Textured nonwoven webs used in manufacturing the present invention can be formed in a continuous process. The textured nonwoven web is made from a filament-forming material, a liquid curable binder resin, and optionally, particles. The filament-forming material can be extruded directly into a lofty, open, porous, filament web. Binder, size resins, and optionally, particles are then applied to the web to provide the finished textured nonwoven web.

In an exemplary web-making process that can be used to make articles according to the present invention, filament-forming material is inserted into an extruder equipped with a spinneret head which has a multitude of openings equally spaced in at least one row, preferably in a plurality of spaced rows of equally spaced openings. The row or rows of molten filaments are then extruded downwardly, permitted to freely fall a short distance through an air space and then into a quench bath. As the filaments enter the quench bath, they begin to coil and undulate, thereby setting up a degree of resistance to the flow of the molten filaments, causing the molten filaments to oscillate just above the bath surface. The spacing of the extrusion openings from which the filaments are formed is such that, as the molten filaments coil and undulate at the bath surface, adjacent filaments touch one another. The coiling and undulating filaments are still sufficiently tacky as this occurs, and where the filaments touch, most adhere to one another to cause autogenous bonding to produce a lofty, open, porous filament web.

The web is then directed into the quench bath between opposed rollers positioned a distance below the surface of the quench bath where the filaments of the integrated mat will still be sufficiently plastic to be permanently deformed as they pass between the rollers. These rollers are typically operated at the same speed but in opposite directions to draw the formed filament web away from the area where the filaments initially coil and bond together. The rollers are spaced to contact the surfaces of the web with slight pressure sufficient to smooth any uneven surface loops or undulations to provide a web with generally flat surfaces. The roller contact will not provide a higher density of filaments at either surface of the web. Instead, the web will have a defined thickness after being passed between the rollers. For this purpose, the surfaces of the rolls are preferably smooth to produce a generally flat surface.

Since useful three-dimensional textured articles may also have non-planar surfaces, the roll surfaces may have other configurations to provide a textured article with a modified surface. For example, a pleated surface roller will produce low-density textured nonwoven webs with a pleated surface. Alternatively, for example, the roller surface may have spikes uniformly disposed on its surface to provide for more secure web handling. The rollers are operated at a surface speed substantially slower than the extrusion speed to permit sufficient time for the filaments to coil and undulate and form a lofty web with a high degree of undulation in each filament. This process produces a web wherein each filament is coiled and undulated throughout its length.

The undulations of each filament are typically irregular although it is possible to adjust the process to produce regular helically coiled filaments. Irregular filament undulation is characterized by random looping, kinking or bending of the filaments through the web in a pattern defined generally by the pattern of openings of the spinneret.

It should be noted that, where more than one row of filaments is extruded, a textured nonwoven web is produced having layers of coiled and undulated filaments, each layer representing a row of extruded filaments. The adjacent filaments between layers will also be autogenously bonded together for the most part where they touch one another.

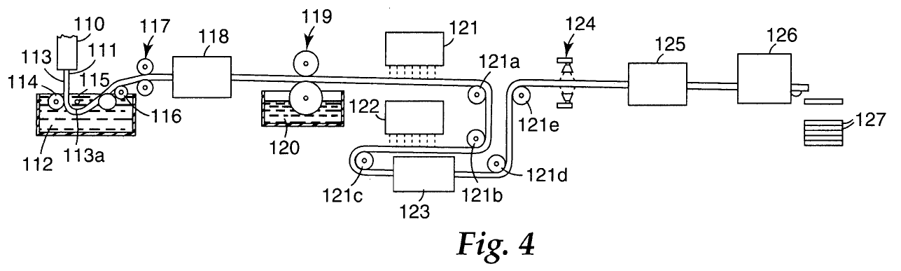

FIG. 4 provides a schematic illustration of an exemplary process used to make a textured nonwoven web for manufacturing three-dimensional articles according to the present invention. As illustrated in FIG. 4, filament-forming material is heated to a molten state and extruded from an extrusion spinneret 110 that contains at least one row of openings to provide a bundle of free-falling filaments 111. Filaments 111 are permitted to freely fall through an air space into a quench bath 112 where they coil and undulate at or near the surface of bath 112 to form an autogenously bonded web 113. While it is still sufficiently plastic to be permanently deformed, web 113 is then passed between opposed smooth-surfaced rollers 114 and 115 that may have a pattern of uniformly spaced spikes projecting from the roller surface that are positioned to provide a substantially flat-surfaced web. Web 113 is then drawn around one of the rollers (e.g., roller 115), for removal from quench bath 112. Web 113 is then passed over idler roll 116 between guide roll set 117 and dried in forced air oven 118 to remove residual quench liquid. The web is wound onto a roll and stored to allow morphological equilibration.

The web is then passed through roll coating station 119 where liquid curable binder resin 120 is applied to web 113. Other conventional web coating techniques may be employed to coat the web so long as such techniques provide a substantially uniform binder resin coating. For example, dip coating and spray-coating techniques may be used.

In certain embodiments, particles are added to the web. The particles may be abrasive particles or agglomerates containing abrasive particles. The web can be made with particles added to one side or both sides of the web. Alternatively, the web can be made without adding particles.

If particles are to be added to the web, the binder resin coating should be sufficient to permit uniform coating of the web with particles. Thereafter, the wet coated web is passed beneath a first particle dropping station 121 to optionally coat the first side of the web with particles. The web is then deployed in an S-shaped arrangement around suitable idler rollers 121a, 121b, 121c, 121d and 121e to reverse the web surfaces (that is, face the second side up). The second side of the web is then passed under a second particle depositing station 122 to optionally coat the second side of the web.

Other particle application or coating devices may also be used (e.g., the particles may be applied by spray methods such as employed in sandblasting except with milder conditions, by electrostatic coating methods, and the like.)

The web is then passed through forced air oven 123, to cure the first binder resin coating. An optional second coating of a size resin can be applied with a suitable device such as spray station 124 that, for example, simultaneously sprays first and second surfaces of the web with a quantity of size resin material. The size resin can be used to further bond the particles to the surface of the web. If present, the quantity of the size resin coating is typically limited so it will not cover or mask the particles. Once coated, the web is then passed through forced air oven 125, and finally into converting station 126 where it is cut into desired shapes 127.

The filament-forming material which is extruded to provide the lofty web contained in a textured article of the present invention is formed of a thermoplastic material which can be extruded through extrusion orifices to form filaments. Particularly useful polyamide materials for forming the filaments of the web for the textured articles according to the present invention are polycaprolactam and poly(hexamethylene adipamide) (e.g., commonly referred to as nylon 6 and nylon 6,6). Other useful filament-forming materials may include polyolefins (e.g., polypropylene and polyethylene), polyesters (e.g., polyethylene terephthalate), polycarbonates, and the like. Multicomponent materials can also be used, including, for example, blends and bicomponent fibers.

Webs produced by the process described above are particularly suited for abrasive articles because they are open, porous, and lofty. As such, the abrasive articles are suitable for prolonged usage for conditioning (e.g., surfaces where large amounts of attrited matter are produced) without filling the web and thus interfering with the textured article's properties. The degree of openness and loftiness is evidenced by the web void volume, which is typically at least about 80% in the uncoated state. In certain embodiments, the web void volume is at least about 85%. In other embodiments, the web void volume is at least 97%.

Webs produced by the process described above are also particularly suited for anti-slip mats. The webs are open, porous, and lofty, and thus permit prolonged usage of the web as a floor mat without filling the web with contaminants, such as dirt and other debris tracked by feet. The porosity of the mat also allows water and other fluids to flow away from the surface.

The addition of particles to the web can provide increased traction. A web made with particles is particularly useful for making an anti-slip covering, including, for example, floor mats, stair tread covers, and ladder rung covers. For example, such coverings can be used in wet or icy environments. Such coverings can also be used where oil or other slippery materials are present.

Upon coating with the binder resin, the web also has a considerable degree of structural integrity that permits prolonged usage of the textured article. The flattening effect of the rollers provides a unique structure that is highly open at the surface yet has a flat face capable of use on flat surfaces without requiring bending or modification of the web.

Textured nonwoven webs may be made in a wide variety of thicknesses, limited principally by the design of the spinneret through which it is extruded and the gap between rollers 114 and 115 illustrated in FIG. 4. Typically, web thicknesses useful in the present invention have an average size of at least about 0.5 cm. In certain embodiments, the web thickness is at least about 1 cm. In yet further embodiments, the web thickness is at least about 1.5 cm. Typically, web thicknesses useful in the present invention have an average size of less than about 8 cm. In certain embodiments, the web thickness is less than about 3 cm. In yet further embodiments, the web thickness is less than about 2 cm.

The filament diameter of the filaments in the web produced by the process described above may be varied by modification of the web-making process. The filament diameter for a suitable web will be at least about 0.1 mm. In certain embodiments, the filament diameter for a suitable web will be at least about 0.3 mm. The filament diameter for a suitable web will be less than about 3 mm. In certain embodiments, the filament diameter for a suitable web will be less than about 0.5 mm.

The openings in the spinneret will be in rows, as previously stated, and separated by at least about 2.5 mm. The openings of adjacent rows may be offset from one another although the spinneret performs suitably when the openings in the rows are aligned.

It should be noted that the diameter of the filaments in the quenched web are not necessarily identical to the diameter of the extrusion orifice from which they were extruded. There may be some thickening of the molten filament near the spinneret openings caused by surface tension that tends to increase the filament diameter. There may also be some decrease of the filament diameter caused by attenuation in the free fall zone between the spinneret and the quench bath surface, the attenuation increasing as the free fall height increases. Typically, the free fall height is at least about 5 cm. In certain embodiments, the free fall height is at least about 12 cm. Typically, the free fall height is less than about 50 cm. In certain embodiments, the free fall height is less than about 38 cm.

Typically, the coil weight of the web should be at least about 0.1 kg/M². As used herein, “coil weight” refers to the weight of the web of undulated polymeric filaments prior to the application of any coatings or particles. In certain embodiments, the coil weight is at least about 0.5 kg/m². The coil weight should be less than about 3.0 kg/m². In certain embodiments, the coil weight is less than about 1.5 kg/m². Although not wanting to be bound by any theory, typically, articles with higher coil weights tend to have a longer useful life.

In certain embodiments, the resin binder material is a polyurethane which may be prepared from commercially available isocyanate prepolymeric materials, such as materials sold under the trade designation “ADIPRENE” L type, for example, L-83, L-100, L-167, and L-315 (commercially available from Crompton & Knowles Corporation, Stamford, Conn.), which may be cured with, for example, p, p′-methylene dianiline (MDA). The reactive isocyanate groups of these materials may be blocked with blocking agents such as ketoxime or phenol to give a liquid material that may be cured with MDA. These materials cure with heating in the temperature range of 104 to 160 degrees Celsius to produce cured binder resin having the requisite physical properties, yet they are initially liquid and have sufficient pot life to use in the present process to produce useable textured articles. The uncured, unblocked prepolymeric materials will have a nominal NCO content in the range of about 3% to 10%, a nominal viscosity at 30 degrees Celsius in the range of about 6000 to 30,000 centipoise, and a specific gravity in the range of about 1.03 to 1.15 at 25 degrees Celsius.

In textured nonwoven webs containing particles, the quantity of binder resin is sufficient to adherently bond the particles throughout the web yet is limited so that it will not cover or mask the particles themselves. Thus, as the size of the particles varies, some modification may be required in the amount of binder resin used. For example, smaller particles may require less binder resin for bonding.

Besides binding the optional particles to the surfaces of the filaments of the web, the binder resin may also provide for additional filament-to-filament bonding in the web itself. While these filaments have been autogenously bonded together during the web forming operation, they may still be separated, especially if large mechanical forces are applied to the textured article. In certain embodiments, the binder resin is applied in an amount in the range of 0.1 kg/m² to 3 kg/m².

Suitable particles can be any known abrasive particles or materials commonly used in abrasive articles. Examples of minerals that provide useful abrasive particles include pumice, topaz, garnet, alumina, corundum, silicon carbide, zirconia, ceramic aluminum oxide, and diamond. Other suitable particles include those of rubber and other elastomers, sand, slag, comminuted nut shells, ground thermoplastic polymer, ground thermoset polymer, glass, mullite, and combinations thereof. Suitable particles also include metallic articles, such as, for example, tire studs, rivets, and the like. The suitable particles may also be agglomerates or composites that include additional components, such as, for example, a binder.

In certain embodiments, the particles have an average size of at least about 0.01 mm. In other embodiments, the particles have an average size of at least about 0.2 mm. In yet further embodiments, the average size is at least 0.5 mm. In certain embodiments, the average particle size is less than about 25 mm. In other embodiments, the average size is less than about 10 mm. In yet further embodiments, the average size is less than about 5 mm.

In certain embodiments that have particles applied to both sides of the web, the particles are applied in an average amount of at least about 100 g/m². In other embodiments, the particles are applied in an average amount of at least 500 g/m². In yet further embodiments, the particles are applied in an average amount of at least 1,000 g/m². In certain embodiments, the particles are applied in an average amount of less than 10,000 g/m². In other embodiments, the particles are applied in an average amount of less than 6,300 g/m². In other embodiments, the particles are applied in an average amount of less than 5,000 g/m². In yet further embodiments, the particles are applied in an average amount of less than 3,500 g/m². In embodiments that have particles applied to only one surface of the web, the above values should be reduced by about 50 percent. In yet further embodiments, the particles may be applied in a random or non-random pattern of stripes, squares, circles, or other geometric shape, rather than covering the full surface of the web. In such an embodiment, the application weight ranges listed above would vary in an amount proportionate to the area of the web where particles are applied.

Textured nonwoven webs used to manufacture the three-dimensional textured articles of the present invention may also contain mixtures of several sizes of particles or different types of particles. Further, the type or amount of particle used on each surface of the web can vary. It will be readily apparent in view of the present invention to modify the textured article for a particular application by selecting the appropriate particle material for the web.

Webs used to manufacture the three-dimensional textured articles of the present invention may also be modified in other ways without departing from the scope of the invention. For example, commonly known additive materials may be employed in the resin binder coating such as metal working lubricants (e.g., metal stearates). Such additives are typically added during the second binder coating operation so as not to interfere with particle adhesion to the filaments.

To further anchor the optional particles to the web, a second, or “size” coating of resin may be applied to the textured article. Size resins suitable for these size coatings can be constitutionally the same as those used for the initial coating, and are applied and hardened in the same manner. In certain embodiments, the coating weights for size resins are in the range of 0.1 to 3 kg/m². In certain embodiments, the size resin includes a yellow colorant, such as, for example, yellow pigment available from Penn Color, Inc., Doylestown, Penn., marketed under the trade designation “YELLOW PIGMENT 16Y1140 PASTE”.

The webs used to manufacture the three-dimensional textured articles of the present invention have an average total weight of at least 0.5 kg/m². In certain embodiments, the average total web weight is at least 1 kg/m². In yet further embodiments, the average total web weight is at least 3 kg/m². In certain embodiments, the average total web weight is less than 18 kg/m². In other embodiments, the average total web weight is less than 6 kg/m². In yet further embodiments, the average total web weight is less than 5 kg/m².

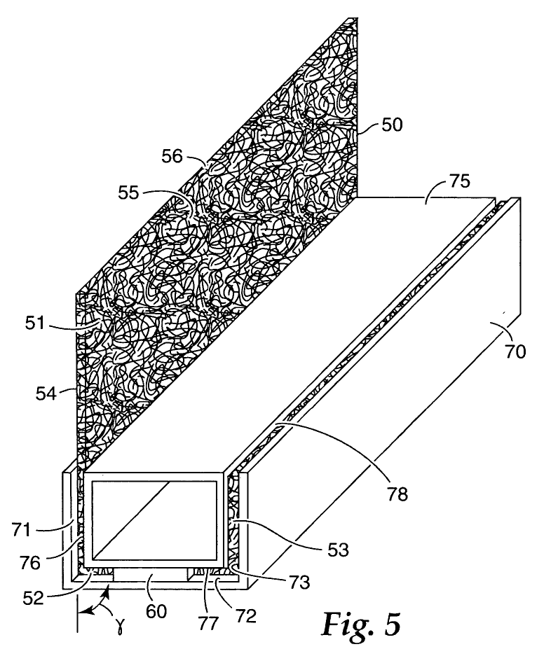

After preparation of the textured nonwoven web, the web can be formed into a variety of three-dimensional shapes. FIG. 5 is a perspective view of exemplary forming trays used to manufacture a three-dimensional textured article. As shown in FIG. 5, the outer forming tray 70 includes a first forming surface 71, a second forming surface 72, and an optional third forming surface 73. The second forming surface 72 is positioned at an angle γ relative to the first forming surface 71. In certain embodiments, angle γ is at least 45 degrees. In other embodiments angle γ is at least 60 degrees. In yet further embodiments, angle γ is at least 75 degree. In certain embodiments, angle γ is about 90 degrees. Alternatively, angle γ can be about 180 degrees such that the first forming surface 71 and the second forming surface 72 are opposite one another with a space between the surfaces to allow entry of the web.

The inner forming tray 75 includes a first forming surface 76, a second forming surface 77, and a third forming surface 78. In certain embodiments, the inner forming tray 75 conforms to the shape of the outer forming tray 70 such that a web can be “sandwiched” between the forming surfaces of the inner forming tray and the forming surfaces of the outer forming tray.

To form the textured nonwoven web into a three-dimensional textured article, the web is cut to a suitable shape and dimension to form a sheet. The sheet is then raised to an elevated temperature. The temperature of the sheet can be elevated using an oven, such as, for example, a forced convection oven, or other known heating techniques. The sheet is elevated to a temperature and held for a duration that is sufficient to soften the sheet. In certain embodiments, the textured nonwoven web is made from nylon 6, the make and size coating is a polyurethane, and the sheet is placed in a forced convection oven set in the range of 190-205 degrees Celsius for 2 to 3 minutes.

The heated sheet is then placed into an appropriately dimensioned forming tray, such as outer forming tray 70 shown in FIG. 5. In certain embodiments, an inner forming tray, such as inner forming tray 75 in FIG. 5, is used to help the web conform to the forming surfaces of the outer forming tray. As shown in FIG. 5, the inner forming tray 75 and outer forming tray 70 can be used to sandwich the sheet. A spacer block 60 can be used to fix the gap between at least a portion of the inner forming tray 75 and the outer forming tray 70. The inner and outer forming tray can have various shapes and dimensions. For example, the inner or outer forming tray can have curved surfaces, planar surfaces, angled surfaces, sharp corners, chamfers, fillets, and the like.

A three-dimensional textured article is produced upon cooling of the sheet to ambient temperature. In certain embodiments, the three-dimensional textured article is not removed from the form until it cools to ambient temperature. The cooling of the sheet sandwiched in the forming trays can be accelerated using methods known in the art, including, for example, forced air, water mist, or other known cooling techniques. The cooling means can be applied either directly to the sheet or to the forming trays. For example, the forming trays can include internal passageways that cooling fluid can pass through.

The three-dimensional textured articles according to the present invention may be manufactured in a variety of shapes and dimensions. For example, suitable shapes include an “L” shape as shown in FIG. 2 and a “C-fold” shape as shown in FIG. 3. Other shapes are also contemplated, including, for example, a “Z” shape and a “G” shape.

Changing the shape of the sheet used can also modify the dimensions and shape of the three-dimensional article. For example, prior to forming into a three-dimensional shape, the textured nonwoven web can be cut to form a sheet of any shape, including, for example, square, rectangle, circle, oval, diamond, and the like.

The three-dimensional textured article according to the present invention may be laminated to other layers to provide a modified three-dimensional textured article. For example, the textured article may be laminated to a foam or sponge layer to provide dual cleaning functions or to provide a cushioning layer. Any of a variety of mounting devices or handles may also be applied to the three-dimensional textured article to provide an implement that may have a removable or permanently attached handle.

The three-dimensional textured articles of the present invention can be used as an abrasive article for use in a variety of situations where a three-dimensional article conforms to the surfaces of the workpiece better than a planar surface. For example, abrasive articles according to the present invention can be used for a variety of applications, including removing paint from metal and wood surfaces, removing heat-treating and tempering oxides from wire rod and circular saw blades, removing thick protective grease coatings and oxide coatings from boiler heat exchange tubes prior to welding, removing rust, dirt and contamination from steel coil during reclaiming operations, removing reflective sheeting materials from highway signs during reclaiming operations, removing slag and oxide from the surface of welded parts, and removing the protective paper coating and hard plastic coatings during the reclamation of plastic sheets such as those formed of polycarbonate. Abrasive articles according to the present invention may also be used, for example, to produce decorative finishes on metal parts such as stainless steel tubing and sheeting.

Advantages and other embodiments of this invention are further illustrated by the following example, but the particular materials and amounts thereof recited in this example, as well as other conditions and details, should not be construed to unduly limit this invention. For example, the dimensions of the textured nonwoven web and the dimensions and angle of the forming trays can be varied to achieve a three-dimensional textured article with other dimensions. All parts and percentages are by weight unless otherwise indicated.

### EXAMPLE

A 58 cm×30 cm sheet of a textured nonwoven made of continuous undulated inter-engaged autogenously bonded filaments available from 3M Company, St. Paul, Minn., and marketed under the trade designation “SCOTCH-BRITE CLEAN AND STRIP SHEET XCS SPR” was heated in a forced-convection oven set in the range of 190 to 205 degrees Celsius for 2-3 minutes.

The heated sheet was then inserted into a room temperature outer forming tray. The outer forming tray was a U-shaped aluminum channel having a first forming surface dimension of 4.0 cm, a second forming surface dimension of 6.3 cm, and a third forming surface dimension of 4.0 cm. The second forming surface was positioned 90 degrees relative to the first forming surface. The third forming surface was positioned 90 degrees relative to the second forming surface, such that the first forming surface and the third forming surface were opposite one another. The aluminum channel of the outer forming tray had a wall thickness of 0.64 cm and was 76 cm long.

1.3 cm thick spacer blocks were placed at each end of the second forming surface of the outer forming tray. A room temperature inner forming tray was then inserted into the outer forming tray to sandwich the heated sheet. The inner forming tray was a rectangular-shaped aluminum tube having a first forming surface dimension of 4.0 cm, a second forming surface dimension of 6.3 cm, and a third forming surface dimension of 4.0 cm. The second forming surface was positioned 270 degrees relative to the first forming surface. The outer ends of the inner forming surface of the inner tray were supported by the two spacer blocks. The third forming surface was positioned 270 degrees relative to the second forming surface, such that the first forming surface and the third forming surface were facing opposite directions. The aluminum channel of the inner forming tray had a wall thickness of 0.32 cm and was 76 cm long.

The sheet was retained between the nested channels by clamps and allowed to cool to room temperature. The molded sheet was then removed from the forming trays. The resulting “C-shaped” textured three-dimensional article was then applied to a 18 cm×61 cm open metal stair step such that the “C” shape wrapped around the front of the stair tread.

It is to be understood that even in the numerous characteristics and advantages of the present invention set forth in above description and examples, together with details of the structure and function of the invention, the disclosure is illustrative only. Changes can be made to detail, especially in matters of shape, size and arrangement of the three-dimensional textured article and methods of making within the principles of the invention to the full extent indicated by the meaning of the terms in which the appended claims are expressed and the equivalents of those structures and methods.

1. A three-dimensional textured article comprising:
a first portion having a first surface, a second surface, and at least one side wall extending between said first and said second surfaces; and
a second portion having a first surface positioned at a substantially permanent angle relative to said first surface of said first portion, a second surface, and at least one side wall extending between said first and said second surfaces of said second portion,
wherein said angle between said first surface of said first portion and said first surface of said second portion is at least 45 degrees; and said first portion and said second portion are integral and comprise a web and a binder, said web comprising a multitude of substantially continuous three-dimensionally undulated thermoplastic filaments autogenously bonded where they contact one another, wherein said filaments have a diameter in a range from 0.1 to 3 mm and said web has a coil weight in a range from 0.1 to 3.0 kg/m².

2. The textured article of claim 1 wherein said thermoplastic filaments comprise a polyamide.

3. The textured article of claim 1 wherein said thermoplastic filaments comprise at least one of polycaprolactam or poly(hexamethylene adipamide).

4. The textured article of claim 1 further comprising a quantity of particles affixed to at least one of said first or second surfaces of said first portion.

5. The textured article of claim 4 wherein said quantity of particles is in the range of 0.1 to 5 kg/m².

6. The textured article of claim 5 wherein said quantity of particles comprise at least one of slag, alumina, thermoplastic polymer, thermoset polymer, glass, mullite, sand, rubber, pumice, topaz, garnet, corundum, silicon carbide, zirconia, ceramic aluminum oxide, or diamond.

7. The textured article of claim 1 wherein said binder comprises polyurethane.

8. The textured article of claim 1 further comprising a size coat.

9. The textured article of claim 8 wherein said size coat comprises polyurethane.

10. The textured article of claim 8 wherein said size coat further comprises yellow colorant.

11. The textured article of claim 8 further comprising a graphic on said first surface of said first portion.

12. The textured article of claim 1 further comprising a third portion integral with at least one of said first or said second portion, said third portion comprising a first surface, a second surface, and at least one side wall extending between said first and said second surfaces of said third portion.

13. The textured article of claim 12 wherein said third portion is integral with said second portion, and said first surface of said third portion is positioned at an angle of at least 45 degrees relative to said first surface of said second portion.

14. The textured article of claim 1 wherein said first and second portions are each substantially planar.

15. The textured article of claim 1 wherein said sidewall extending between said first and second surfaces of said first portion is in the range of 0.5 cm to 8 cm high.

16. A stair tread cover comprising the textured article of claim 1.

17. A stairway comprising the textured article of claim 1.

18. A ladder rung comprising the textured article of claim 1.

19. A method for making a three-dimensional textured article comprising:
providing a nonwoven sheet comprising a web and a binder, said web comprising a multitude of substantially continuous three-dimensionally undulated thermoplastic filaments autogenously bonded where they contact one another, wherein said filaments have a diameter in a range from 0.1 to 3 mm and said nonwoven sheet has a coil weight in a range from 0.1 to 3.0 kg/m²;
heating at least a portion of said nonwoven sheet;
positioning a first portion of said nonwoven sheet at an angle relative to a second portion of said nonwoven sheet; and
cooling said nonwoven sheet to form a substantially permanent angle of at least 45 degrees between a first surface of said first portion and a first surface of said second portion.

20. The method of claim 19 further comprising:
providing an outer forming tray comprising a first forming surface and a second forming surface positioned at an angle relative to said first forming surface; and
placing at least a portion of said nonwoven sheet in said outer forming tray such that said first portion of said nonwoven sheet contacts said first forming surface and said second portion of said nonwoven sheet contacts said second forming surface.

21. The method of claim 20 further comprising cooling said nonwoven sheet in said forming tray.

22. The method of claim 20 further comprising placing an inner forming tray in at least a portion of said outer forming tray such that at least one of said first portion or said second portion of said nonwoven sheet simultaneously contacts said inner and said outer forming trays.

23. The method of claim 19 wherein said heating occurs in an oven set at a temperature in the range of 190 to 205 degrees Celsius.

24. The method of claim 19 wherein said thermoplastic filaments comprise a polyamide.

25. The method of claim 19 further comprising printing said nonwoven sheet.

26. The method of claim 19 wherein said nonwoven sheet further comprises a quantity of particles.
